(19) United States
(12) Patent Application Publication
(10) Pub. No.: US 2017/0186096 A1
(43) Pub. Date: Jun. 29, 2017

(54) SYSTEM CONFIGURATIONS FOR TARGET AMOUNT ACCUMULATION

(71) Applicant: PAYPAL, INC., San Jose, CA (US)

(72) Inventor: David Edward Eramian, Mountain View, CA (US)

(21) Appl. No.: 14/983,286

(22) Filed: Dec. 29, 2015

(51) Int. Cl. G06Q 40/00; G06F 3/0481; G06Q 20/10; G06F 3/0484

(52) U.S. Cl. CPC G06Q 40/12; G06F 3/0484; G06F 3/0481; G06Q 20/10

(57) ABSTRACT

Various systems, mediums, and methods herein describe mechanisms to receive user requests based on an input to graphical user interface of a client device. An exemplary system may determine a target amount associated with an available item and a time period to accumulate the target amount. The system may determine a number of expected transfers that corresponds to the time period. The system may determine a respective additional amount for each of the number of expected transfers such that an accumulation of the respective additional amounts is equal to the target amount. The system may cause the graphical user interface of the client device to display the respective additional amounts with the number of expected transfers.

### TECHNICAL FIELD

This disclosure generally relates to mobile device technology and related data infrastructure systems for accumulating target amounts.

### BACKGROUND

Reaching a goal can be a difficult task. For example, an individual attempting to achieve a given goal may have difficulty determining how to reach the goal. In particular, there may be several options or paths to reach the goal and it may be difficult to determine which option or path to select. Yet further, for a particular path selected, there may be additional challenges with determining which steps to take in order to get started. As such, the individual may turn to a computing device to help direct their efforts. In particular, the computing device may provide various forms of information to the user to help guide the user in reaching the particular goal.

Yet the user may face a number of challenges. For example, consider a scenario where the user relies on a smartphone to reach a given goal. In this scenario, consider how the user may be unsatisfied if the smartphone provides information that is not particularly suitable to the user, possibly based on the smartphone lacking information regarding the user. As such, the user may be required to provide various forms of data to the smartphone, which may be time consuming and cumbersome. In addition, the smartphone may not regularly provide up-to-date information to the user to help the user reach the goal, possibly due to the smartphone's capabilities (e.g., hardware or software limitations) and various aspects related to the data infrastructure. For example, the smartphone may receive delayed updates based on various bottlenecks with the data architecture, possibly resulting in inefficiencies with utilizing the smartphone to reach the goal.

As demonstrated in the scenario above, there is much need for technological advancements in various aspects of mobile technology and the capabilities of the data infrastructure to support users and facilitating users to reach their goals intelligently.

### BRIEF DESCRIPTION OF THE DRAWINGS

FIG. 1 is a block diagram of an exemplary system, according to an embodiment;

FIG. 2A illustrates an exemplary system configured to support a set of trays, according to an embodiment;

FIG. 2B illustrates an exemplary tray configured to support one or more components, according to an embodiment;

FIG. 3A illustrates a target amount, according to an embodiment;

FIG. 3B illustrates a number of expected transfers, according to an embodiment;

FIG. 3C illustrates a number of respective additional amounts, according to an embodiment;

FIG. 3D illustrates a number of additional transfers, according to an embodiment;

FIG. 4A illustrates a number of target amounts, according to an embodiment;

FIG. 4B illustrates a number of respective additional amounts, according to an embodiment;

FIG. 5A illustrates a balance, according to an embodiment;

FIG. 5B illustrates an increase in respective additional amounts, according to an embodiment;

FIG. 5C illustrates a decrease in respective additional amounts, according to an embodiment;

FIG. 6 illustrates an exemplary system with a client device, according to an embodiment;

FIG. 7A illustrates an exemplary method, according to an embodiment;

FIG. 7B illustrates an exemplary method, according to an embodiment;

FIG. 8 illustrates an exemplary system with a client device, according to an embodiment; and

FIG. 9 illustrates an exemplary wearable computing device, according to an embodiment.

Embodiments of the present disclosure and their advantages may be understood by referring to the detailed description herein. It should be appreciated that reference numerals may be used to illustrate various elements and features provided in the figures. Further, the figures may illustrate various examples for purposes of illustration and explanation related to the embodiments of the present disclosure and not for purposes of any limitation.

### DETAILED DESCRIPTION

As described in the scenarios above, there may be various circumstances where a user may wish to achieve a given goal. Example embodiments herein describe various aspects of mobile technology and the data infrastructure to provide data to the user such that the user may determine possibly ways to achieve their goals intelligently.

In practice, for example, consider a scenario where a user wishes to save a target amount of funds for a particular item, such as a barbecue grill. The user may face various challenges in determining how much should be saved periodically such that the user can obtain the grill in a timely manner, such as during the spring or at any given time before the beginning of summer. Further, the user may find difficulties in determining how much and how often to save based on the user's balance and/or fluctuations of the user's balance over time. For example, the user may incur losses to their balance during certain times and the user may not be able to save the predetermined amounts as planned. As such, the user may face inconveniences of often managing and making changes to the plan to accumulate the target amount in a timely manner.

In view of the difficulties and challenges described above, a service provider may operate a system that performs operations such that the user may accumulate the target amount intelligently. For example, consider that the user enters a request into their smartphone that indicates a target amount to obtain an item (e.g., the barbecue grill) and possibly also a time period to accumulate the target amount (e.g., the spring time period before the beginning of summer). The system may receive the request and determine a number of expected transactions or fund transfers that the user is likely to make in the time period specified. For example, the system may identify recurring transactions or fund transfers often made by the user, such as transfers that the user may make on a daily basis.

For example, the user may transfer funds to purchase lunch every day at a given food court or a cafeteria. As such, the system may estimate amounts transferred on a daily basis. Yet, the system may also determine an additional amount for each of the daily transfers such that over time, the additional amounts may be withdrawn from the user's account and saved, possibly in a separate account. For instance, consider a scenario where the user regularly transfers approximately ten dollars for lunch on a daily basis. In this scenario, the system may withdraw thirteen dollars from the user's account and the extra three dollars may be deposited in a separate account to save for the desired item, e.g., the barbecue grill. At the end of the week, there may be fifteen to twenty dollars accumulated in the account, for example. Further, at the end of the month, there may be sixty to ninety dollars accumulated in the account and possibly seven hundred dollars to over a thousand dollars by the end of the year. Considering the scenarios above, the user may be able to save for the barbecue grill in a few months within the spring time frame without having to consider variable amounts that may be saved with expected transactions or fund transfers.

Notably, the system may determine other expected transfers. In particular, the system may determine expected transfers made on a weekly basis, a bi-weekly basis, a monthly basis, and/or another periodic basis. As such, the system may withdraw respective additional amounts from the user's account based on such other expected transfers. For example, the system may withdraw respective additional amounts based on expected transfers for obtaining gas, going out to dinner, going to the movies, and/or other related activities that may occur on a weekly or a bi-weekly basis. Yet further, the system may withdraw respective additional amounts based on transferring amounts for rent, mortgages, utilities, and/or other transfers that may occur on a monthly basis, among other possibilities.

Further, the system may also transmit notifications to the user's smartphone indicating the amounts accumulated over time such that the user may be made aware of the progress made to reach the target amount. As such, the user may be able to save for the target amount without having to provide various forms of data to the smartphone. For instance, the user may save the target amount without having to provide data particular to the user, such as the user's expected transfers over one or more time periods. Further, the user may reach the target amount without having to provide data periodically and/or on a regular basis. Instead, the user may rely on the system, such as aspects of the smartphone and the data architecture, to accumulate amounts over time intelligently, where the sum of the amounts equals the target amount.

The system may perform additional operations. For example, the system may determine other transfers by the user, possibly in addition to the expected transfers. For example, considering the scenarios above, the system may determine that the user is transferring unexpected amounts from the user's account to buy shoes, pants, shirts, coats, jackets, and/or other forms of clothing. The system may also determine unexpected amounts transferred to obtain electronics such as smartphones, keyboards, headphones, and/or other electronic accessories. As such, the system may determine the user is transferring unexpected amounts to obtain items that may not correspond to expected transfers (e.g., periodic transfers). In such instances, the system may withdraw additional amounts from the user's account based on these unexpected transfers. Yet further, the system may accordingly adjust the respective additional amounts planned to be withdrawn based on the various such transfers.

In some instances, the system may also predict, forecast, and/or estimate a number of transfers, such as non-recurring and/or non-periodic transfers, such as meals, gift purchases for the user or others, drinks, impulse purchases, sales purchases, and any other fund transfers using the service provider. Thus, the system may determine an average number of transfers and/or dollar amount of transfers over certain periods of time to estimate how much should be saved for each transfer or as a percentage of the transfer amount to reach a desired savings goal. The certain periods can be based on the length of time the user specifies for reaching a savings goal and may depend, in part, on the time of year. For example, in certain times of the year (such as the Christmas shopping season), both the number of transfers and the corresponding amounts would likely be greater than other times of the year. Periods that include an anniversary, vacation, birthday, Valentine's Day, and the like may also have a higher number of transactions and/or a higher amount of fund transfers.

The system may also track the target amount based on the desired item, possibly referred to herein as the target item. For example, considering the scenarios above, the barbecue grill may go on sale, possibly due to a spring season sale. As such, the target amount may be lowered. In such instances, the system may adjust the additional amounts planned to be withdrawn accordingly. Further, in some instances, the spring season sale may be available for a short time period. As such, in some instances, the system may increase the additional amounts planned to be withdrawn such that the target amount may be saved in time for the spring season sale during the short time period. For example, the system may send notifications to the user's smartphone to inform the user of the spring season sale and the user may be asked to accept the increase in the additional amounts planned such that the target amount may be saved in time for the spring season sale. Yet further, the system may send notifications to the smartphone indicating how many items, e.g., barbecue grills, are left or available under the sale, possibly throughout the spring season sale. As such, the system may facilitate the user in making informed decisions to accept such increases in additional amount retrieved.

In some embodiments, the system may receive a request to save for a first target amount and a second target amount. For example, the first target amount may be saved for a first target item, such as the barbecue grill, and the second target amount may be saved for a second target item, such as a lawnmower. As such, the system may accordingly determine respective additional amounts to be withdrawn and saved based on the expected transfers. For example, a first additional amount for an expected transfer may be withdrawn and saved for the grill. Further, a second additional amount for the expected transfer may be withdrawn and saved for the lawnmower. In some instances, the barbecue grill may be prioritized higher than the lawnmower such that the first additional amount is greater than the second additional amount, among other possibilities.

In some embodiments, the system may determine a present balance of the user account. As such, the system may determine the respective additional amounts withdrawn with the expected transfers based on the present balance of the user account. For example, the system may compare the present balance with a threshold balance of the user account. As such, the system may determine whether the present balance is higher or lower than the threshold balance. Further, the system may determine the respective additional amounts for the expected transfers based on the present balance in comparison with the threshold balance, among other possibilities.

The example embodiments described herein may resolve various challenges with accumulating target amounts utilizing data transfers with mobile devices and the data infrastructure, possibly including one or more computer networks. As such, various embodiments may resolve problems that did not exist before the availability of the computer networks and/or the Internet. In particular, such embodiments may solve problems specific to transferring data over computer networks of the data infrastructures (e.g., the Internet) to accumulate target amounts. Various such embodiments may also include solutions that are technical in nature and/or rooted in data transfer mechanisms of mobile devices and the data infrastructure. Further, such embodiments may provide unconventional steps confined to one or more particular useful applications related to transferring data with mobile device and the data infrastructure, possibly to accumulate the target amounts over one or more time periods as contemplated herein.

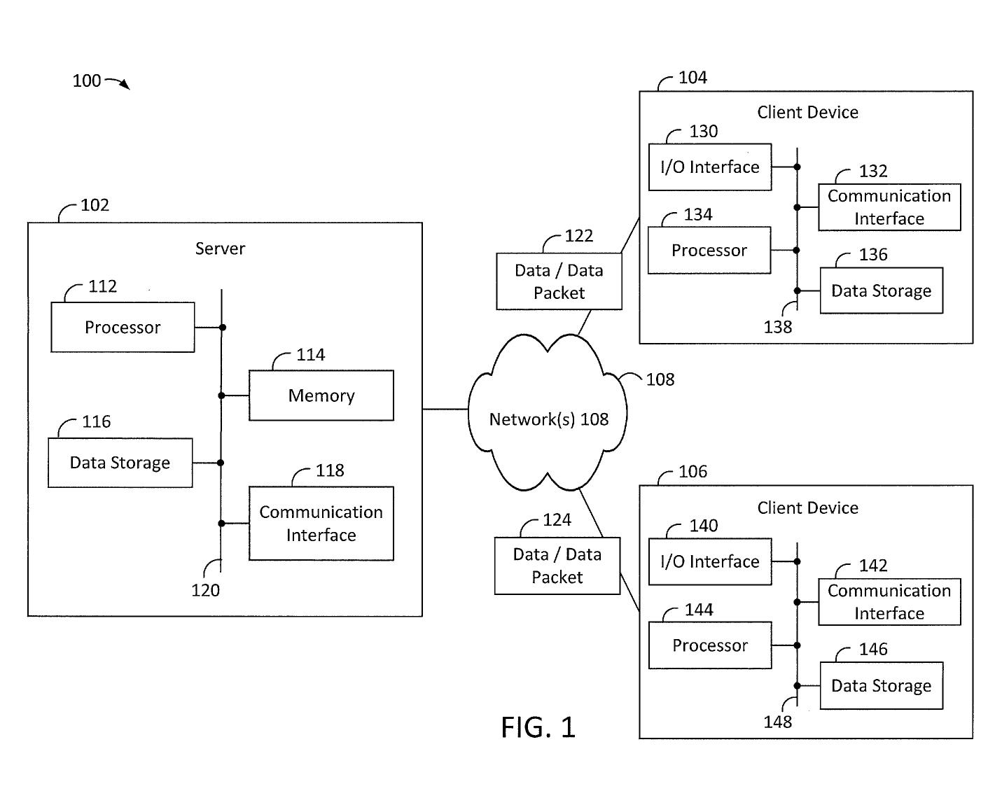

FIG. 1 is a block diagram of an exemplary system 100, according to an embodiment. The system 100, possibly referred to as the data infrastructure 100, may be configured to transfer data over one or more communication networks 108. In particular, the system 100 may include the server 102, possibly referred to as the server system 102. The server 100 may be configured to perform operations of a service provider, such as PayPal, Inc. of San Jose, Calif., USA. Further, the system 100 may also include client device 104 and the client device 106. As such, the server 102 and the client devices 104 and 106 may be configured to communicate over the one or more communication networks 108. As shown, the system 100 includes multiple computing devices but may also include other possible computing devices as well.

The system 100 may operate with more or less than the computing devices shown in FIG. 1, where each device may be configured to communicate over one or more communication networks 108, possibly to transfer data accordingly. In some instances, the one or more communication networks 108 may include a data network, a computer network, and a communications network such as a telecommunications network and/or a cellular network, among other possible networks. In some instances, the communication network 108 may include web servers, network adapters, switches, routers, network nodes, base stations, microcells, and/or various buffers/queues to transfer data/data packets 122 and/or 124.

The data/data packets 122 and/or 124, may be transferrable using communication protocols such as packet layer protocols, packet ensemble layer protocols, and/or network layer protocols, among other protocols and/or communication practices. For example, the data/data packets 122 and/or 124 may be transferrable using transmission control protocols and/or internet protocols (TCP/IP). In various embodiments, each of the data/data packets 122 and 124 may be assembled or disassembled into larger or smaller packets of varying sizes, such as sizes from 1,000 to 1,500 bytes, for example, among other possible data sizes. As such, data/data packets 122 and/or 124 may be transferrable over the one or more networks 108 and to various locations in the data infrastructure 100.

In some embodiments, the server 102 may take a variety of forms. The server 102 may be an enterprise server, possibly operable with one or more operating systems to facilitate the scalability of the data infrastructure 100. For example, the server 102 may operate with a Unix-based operating system configured to integrate with a growing number of other servers, client devices 104 and/or 106, and other networks 108 over the system architecture 100. The server 102 may further facilitate workloads associated with numerous data transfers in view of an increasing number of user requests to accumulate target amounts for numerous user accounts. In particular, the server 102 may facilitate the scalability relative to such increasing number of user requests to eliminate data congestion, bottlenecks, and/or transfer delays.

In some embodiments, the server 102 may include multiple components, such as one or more hardware processors 112, non-transitory memories 114, non-transitory data storages 116, and/or communication interfaces 118, among other possible components, any of which may be communicatively linked via a system bus, network, or other connection mechanism 120. The one or more hardware processors 112 may take the form of a multi-purpose processor, a microprocessor, a special purpose processor, a digital signal processor (DSP) and/or other types of processing components. For example, the one or more hardware processors 112 may include an application specific integrated circuit (ASIC), a programmable system-on-chip (SOC), and/or a field-programmable gate array (FPGA) to process an increasing number of user requests to accumulate target amounts for numerous accounts. In particular, the one or more hardware processors 112 may include a variable-bit (e.g., 64-bit) processor architecture configured for facilitating the scalability of the increasing number of user requests. As such, the one or more hardware processors 112 may execute varying instructions sets (e.g., simplified and complex instructions sets) with fewer cycles per instruction than other conventional general-purpose hardware processors to improve the performance of the server 102.

In practice, for example, the one or more hardware processors 112 may be configured to parse the one or more data packets 122 to receive a user request from the client device 104. The one or more hardware processors 112 may determine a target amount associated with a desired item available to the user. As such, the one or more hardware processors 112 may determine a number of expected transfers that correspond to the user's account. Further, the one or more hardware processors 112 may also determine a respective additional amount for each of the expected transfers to withdraw from the user's account, possibly to store the respective additional amounts in a separate account, for example. As such, the accumulation or sum of the respective additional amounts may be greater than or equal to the target amount.

Further, the one or more hardware processors 112 may further parse the one or more data packets 124 to receive a second user request from the client device 106. The one or more hardware processors 112 may determine a second target amount associated with another desired item available to the second user. As such, the one or more hardware processors 112 may determine a number of expected transfers that correspond to the second user's account. Further, the one or more hardware processors 112 may also determine a respective additional amount for each of the expected transfers to withdraw from the second user's account, possibly to store the respective additional amounts in a separate account for the second user, for example. As such, the accumulation or sum of the respective additional amounts accumulated may be greater than or equal to the second target amount.

The non-transitory memory component 114 and/or the non-transitory data storage 116 may include one or more volatile, non-volatile, and/or replaceable storage components, such as magnetic, optical, and/or flash storage that may be integrated in whole or in part with the one or more hardware processors 112. Further, the memory component 114 may include or take the form of a non-transitory computer-readable storage medium, having stored thereon computer-readable instructions that, when executed by the hardware processing component 112, cause the server 102 to perform operations, such as those described in this disclosure, illustrated by the accompanying figures, and/or otherwise contemplated herein.

The communication interface or component 118 may take a variety of forms and may be configured to allow the server 102 to communicate with one or more devices, such as the client devices 104 and/or 106. For example, the communication interface 118 may include a transceiver that enables the server 102 to communicate with the client devices 104 and/or 106 via the one or more communication networks 108. Further, the communication interface 118 may include a wired interface, such as an Ethernet interface, to communicate with the client devices 104 and/or 106. Yet further, the communication interface 118 may include a wireless interface, such as a cellular interface such as a Global System for Mobile Communications (GSM) interface, a Code Division Multiple Access (CDMA) interface, and/or a Time Division Multiple Access (TDMA) interface. In addition, the communication interface 118 may include a wireless local area network interface such as a WI-FI interface configured to communicate with a number of different protocols. As such, the communication interface 118 may include a wireless interface operable to transfer data over short distances utilizing short-wavelength radio waves in approximately the 2.4 to 2.485 GHz range. In some instances, the communication interface 118 may send/receive data or data packets 122 and/or 124 to/from client devices 104 and/or 106.

The client devices 104 and 106 may also be configured to perform a variety of operations such as those described in this disclosure, illustrated by the accompanying figures, and/or otherwise contemplated herein. In particular, the client devices 104 and 106 may be configured to transfer data/data packets 122 and/or 124 with the server 102, that include user requests to save target amounts, time data that indicates one or more time periods to accumulate the target amounts, and/or item data that indicates the available items desired. The data/data packets 122 and/or 124 may also include location data such as Global Positioning System (GPS) data or GPS coordinate data, triangulation data, beacon data, WI-FI data, peer data, social media data, sensor data, movement data, temperature data, and/or other types of data described or contemplated herein.

In some embodiments, the client devices 104 and 106 may include or take the form of a smartphone system, a personal computer (PC) such as a laptop device, a tablet computer device, a wearable computer device, a head-mountable display (HMD) device, a smart watch device, and/or other types of computing devices configured to transfer data. The client devices 104 and 106 may include various components, including, for example, input/output (I/O) interfaces 130 and 140, communication interfaces 132 and 142, hardware processors 134 and 144, and non-transitory data storages 136 and 146, respectively, all of which may be communicatively linked with each other via a system bus, network, or other connection mechanisms 138 and 148, respectively.

The I/O interfaces 130 and 140 may be configured to receive inputs from and provide outputs to one or more users of the client devices 104 and 106. For example, the I/O interface 130 may include a display that renders a graphical user interface (GUI) configured to receive an input that indicates a user request to save for a target amount. Thus, the I/O interfaces 130 and 140 may include displays and/or other input hardware with tangible surfaces such as touchscreens with touch sensitive sensors and/or proximity sensors. The I/O interfaces 130 and 140 may also be synched with a microphone configured to receive voice commands, a computer mouse, a keyboard, and/or other input mechanisms. In addition, I/O interfaces 130 and 140 may include output hardware such as one or more touchscreen displays, sound speakers, other audio output mechanisms, haptic feedback systems, and/or other hardware components.

In some embodiments, communication interfaces 132 and 142 may include or take a variety of forms. For example, communication interfaces 132 and 142 may be configured to allow client devices 104 and 106, respectively, to communicate with one or more devices according to a number of protocols described or contemplated herein. For instance, communication interfaces 132 and 142 may be configured to allow client devices 104 and 106, respectively, to communicate with the server 102 via the communication network 108. The processors 134 and 144 may include one or more multi-purpose processors, microprocessors, special purpose processors, digital signal processors (DSP), application specific integrated circuits (ASIC), programmable system-on-chips (SOC), field-programmable gate arrays (FPGA), and/or other types of processing components.

The data storages 136 and 146 may include one or more volatile, non-volatile, removable, and/or non-removable storage components, and may be integrated in whole or in part with processors 134 and 144, respectively. Further, data storages 136 and 146 may include or take the form of non-transitory computer-readable mediums, having stored thereon instructions that, when executed by processors 134 and 144, cause the client devices 104 and 106 to perform operations, respectively, such as those described in this disclosure, illustrated by the accompanying figures, and/or otherwise contemplated herein.

In some embodiments, the one or more communication networks 108 may be used to transfer data between the server 102, the client device 104, the client device 106, and/or other computing devices associated with the data infrastructure 100. The one or more communication networks 108 may include a packet-switched network configured to provide digital networking communications and/or exchange data of various forms, content, type, and/or structure. The communication network 108 may include a data network such as a private network, a local area network, and/or a wide area network. Further, the communication network 108 may include a cellular network with one or more base stations and/or cellular networks of various sizes.

In some embodiments, the client device 104 may generate a user request to save for a target amount. For example, the user request may be encoded in the data/data packet 122 to establish a connection with the server 102. As such, the user request may initiate a search of an internet protocol (IP) address of the server 102, that may, for example, take the form of the IP address, “192.168.1.102,” for example. In some instances, an intermediate server, e.g., a domain name server (DNS) and/or a web server, possibly in the one or more networks 108 may identify the IP address of the server 102 to establish the connection between the client device 104 and the server 102. As such, the server 102 may determine the target amount from the user request and determine a respective additional amount for each of a number of expected transfers of the user such that an accumulation or sum of the respective additional amounts is greater than or equal to the target amount.

In some embodiments, the server 102 may include a non-transitory memory, possibly integrated with the non-transitory memory 114, where the non-transitory memory includes instructions. The one or more of the hardware processors 112 coupled to the non-transitory memory may be configured to read the instructions to cause the server system 102 to perform operations. For example, the operations may include receiving a user request based an input to a graphical user interface, e.g., I/O interface 130, of the client device 104. Further, the operations may include determining a target amount associated with an available item and a time period to accumulate the target amount, possibly specified by a user of the client device 104. The operations may also include determining a number of expected transfers that corresponds to the time period, where the number of expected transfers is associated with the user's account. The operations may also include determining a respective additional amount for each of the number of expected transfers such that an accumulation or sum of the respective additional amounts is greater than or equal to the target amount. As such, the operations may include causing a graphical user interface (GUI), the I/O interface 130, to display the respective additional amounts with the number of expected transfers.

It can be appreciated that the server 102 and the client devices 104 and/or 106 may be deployed in various other ways. For example, the operations performed by the server 102 and/or the client devices 104 and 106 may be performed by a greater or a fewer number of devices. Further, the operations performed by two or more devices may be combined and performed by a single device. Yet further, the operations performed by a single device may be separated or distributed among the server 102 and the client devices 104 and/or 106. In addition, it should be noted that the client devices 104 and/or 106 may be operated and/or maintained by the same entities. Yet further, the client devices 104 and/or 106 may be operated and/or maintained by different entities such that each client device 104 and/or 106 may be associated with one or more accounts.

Notably, the user account may be displayed on the client device 104, possibly through I/O interface 130. Thus, the user account may be displayed on a smartphone system and/or any of the devices described or contemplated herein to access the account. For example, the user may manage one or more of their accounts on the client device 104. In particular, the user may view a main account and also a separate account that accumulates the respective additional amounts withdrawn from the main account for the number of expected transfers.

Further, an account or a user account may take a number of different forms. For example, the user account may include a compilation of data associated with a given user. For example, an account for a particular user may include data related to the user's interest. Some examples of accounts may include accounts with service providers described above and/or other types of accounts with funds, balances, and/or check-outs, such as e-commerce related accounts. Further, accounts may also include social networking accounts, e-mail accounts, smartphone accounts, music playlist accounts, video streaming accounts, among other possibilities. Further, the user may provide various types of data to the account via a user device, such as the client device 104.

In some embodiments, a user may have a single user account with a given service provider that may represent the user for multiple other service providers, applications, and/or services, among other possibilities. For example, the single user account may represent the user for e-mail accounts, social networking accounts, smartphone accounts, as well as websites, applications, and/or other services. As such, a user could opt to use the single user account as a multi-purpose account for performing various operations, including generating user requests to accumulate target amounts based on expected transfers of the single user account.

In some embodiments, a user account may be created for one or more users. For example, an account may be a family account created for multiple family members, where each member may have access to the account. In some instances, the account may be a corporate account, where employees, staff, worker personnel, and/or contractors, among other individuals may have access to the corporate account. Yet further, it should be noted that a user, as described herein, may be a number of individuals or even a robot, a robotic system, a computing device, a computing system, and/or another form of technology capable of transferring data corresponding to the account. The user may be required to provide a login, a password, a code, an encryption key, authentication data, and/or other types of data to access to the account.

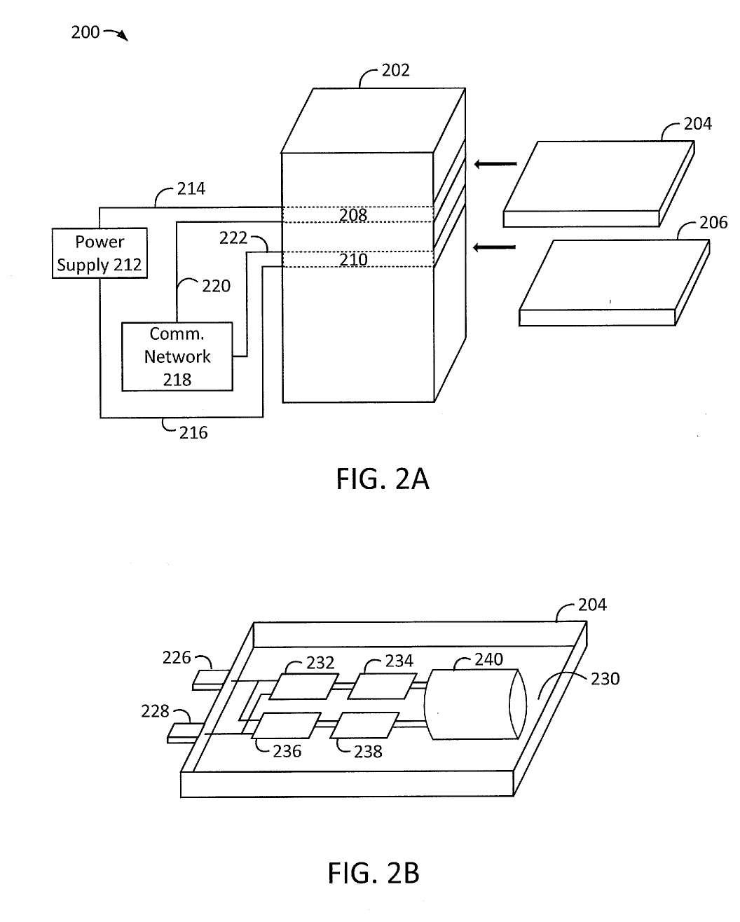

FIG. 2A illustrates exemplary system 200 configured to support a set of trays 204 and 206, according to an embodiment. The system 200 may, for example, include or take the form of the server 102 described above in relation to FIG. 1. In particular, the system 200 may also be referred to as the server 200 or the server system 200. As such, the system 200 may receive user requests from numerous client devices, such as the client devices 104 and/or 106. The system 200 may further support, operate, run, and/or manage the applications, websites, platforms, and/or other compilations of data to accumulate target amounts in association various user accounts.

As shown, the system 200 may include a chassis 202 that may support trays 204 and 206, possibly also referred to as servers or server trays 204 and/or 206. Notably, the chassis 202 may support multiple other trays as well. The chassis 202 may include slots 208 and 210, among other possible slots, configured to hold or support trays 204 and 206, respectively. For example, the tray 204 may be inserted into the slot 208 and the tray 206 may be inserted into the slot 210. Yet, the slots 208 and 210 may be configured to hold the trays 204 and 206 interchangeably such that the slot 208 may be configured to hold the tray 206 and the slot 210 may be configured to hold the tray 204.

Further, the chassis 202 may be connected to a power supply 212 via connections 214 and 216 to provide power to the slots 208 and 210, respectively. The chassis 202 may also be connected to the communication network 218 via connections 220 and 222 to provide network connectivity to the slots 208 and 210, respectively. As such, trays 204 and 206 may be inserted into slots 208 and 210, respectively, and power supply 212 may supply power to trays 204 and 206 via connections 214 and 216, respectively. Further, trays 204 and 206 may be inserted into the slots 210 and 208, respectively, and power supply 212 may supply power to trays 204 and 206 via connections 216 and 214, respectively.

Yet further, trays 204 and 206 may be inserted into slots 208 and 210, respectively, and communication network 218 may provide network connectivity to trays 204 and 206 via connections 220 and 222, respectively. In addition, trays 204 and 206 may be inserted into slots 210 and 208, respectively, and communication network 218 may provide network connectivity to trays 204 and 206 via connections 222 and 220, respectively. The communication network 218 may, for example, take the form of the one or more communication networks 108, possibly including one or more of a data network and a cellular network. In some embodiments, the communication network 218 may provide a network port, a hub, a switch, or a router that may be connected to an Ethernet link, an optical communication link, a telephone link, among other possibilities.

In practice, the tray 204 may be inserted into the slot 208 and the tray 206 may be inserted into the slot 210. During operation, the trays 204 and 206 may be removed from the slots 208 and 210, respectively. Further, the tray 204 may be inserted into the slot 210 and the tray 206 may be inserted into the slot 208, and the system 200 may continue operating, possibly based on various data buffering mechanisms of the system 200. Thus, the capabilities of the trays 204 and 206 may facilitate uptime and the availability of the system 200 beyond that of traditional or conventional servers that are required to run without interruptions. As such, the server trays 204 and/or 206 facilitate fault-tolerant capabilities of the server system 200 to further extend times of operation. In some instances, the server trays 204 and/or 206 may include specialized hardware, such as hot-swappable hard drives, that may be replaced in the server trays 204 and/or 206 during operation. As such, the server trays 204 and/or 206 may be impervious to interruptions to further increase uptime.

FIG. 2B illustrates an exemplary tray 204 configured to support one or more components, according to an embodiment. The tray 204, possibly also referred to as the server tray 204, may take the form of the tray 204 described in relation to FIG. 2A. Further, the tray 206 may also take the form of the tray 204. As shown, the tray 204 may include a tray base 230 that may include the bottom surface of the tray 204. The tray base 230 may be configured to support multiple components such as the hard drives described above and a main computing board connecting one or more components 232-240. The tray 204 may include a connection 226 that may link to the connections 214 or 216 to supply power to the tray 204. The tray 204 may also include a connection 228 that may link to the connections 220 or 222 to provide network connectivity to the tray 204. The connections 226 and 228 may be positioned on the tray 204 such that upon inserting the tray 204 into the slot 208, the connections 226 and 228 couple directly with the connections 214 and 220, respectively. Further, upon inserting the tray 204 into the slot 210, the connections 226 and 228 may couple directly with connections 216 and 222, respectively.

In some embodiments, the tray 204 may include a processor component 232, a memory component 234, a data storage component 236, a communication component and/or interface 238, that may, for example, take the form of the hardware processor 112, the non-transitory memory 114, the non-transitory data storage 116, and the communication interface 118, respectively. Further, the tray 204 may include the data engine component 240 that may maintain numerous user accounts to accumulate target amounts for each account accordingly. As such, the connections 226 and 228 may be configured to provide power and network connectivity, respectively, to each of the components 232-240. In some embodiments, one or more of the components 232-240 may perform operations described herein, illustrated by the accompanying figures, and/or otherwise contemplated. In some embodiments, the components 232-240 may execute instructions on a non-transitory, computer-readable medium to cause the system 200 to perform such operations.

As shown, the processor component 232 may take the form of a multi-purpose processor, a microprocessor, a special purpose processor, a digital signal processor (DSP). Yet further, the processor component 232 may take the form of an application specific integrated circuit (ASIC), a programmable system on chip (PSOC), field-programmable gate array (FPGA), and/or other types of processing components. For example, the processor component 232 may take the form of a processor component configured to receive a user request based an input to a graphical user interface of a client device, such as the client device 104. The processor component 232 may determine a target amount associated with an available item and a time period to accumulate the target amount, possibly specified by a user of the client device 104. The processor component 232 may determine a number of expected transfers that corresponds to the time period, where the number of expected transfers is associated with the user's account. The processor component 232 may determine a respective additional amount for each of the number of expected transfers such that an accumulation or sum of the respective additional amounts is equal to the target amount. As such, the operations may include causing a graphical user interface (GUI), possibly provided by the I/O interface 130, to display the respective additional amounts with the number of expected transfers.

In some embodiments, the processor component 232 may be configured with a Unix-based operating system, possibly to support scalability with various other servers and/or data infrastructures. In particular, the processor component 232 may be configured to be scalable with other servers of various forms that may, for example, include server trays, blades, and/or cartridges similar to the server trays 204 and/or 206. In some instances, the processor component 232 may be configured with scalable process architectures, including, reduced instruction set architectures. In some instances, the processor component 232 may be backwards compatible with various legacy systems such that the processor component 232 may receive, read, and/or execute instruction sets with legacy formats and/or structures. As such, the processor component 232 generally has capabilities beyond that of general-purpose processors.

The database engine component 240 may include one or more secure databases to track numerous user accounts and target amounts associated with the user accounts. For example, the database engine component 240 may include secured databases to track amounts accumulated for numerous user accounts. For example, the database engine component 240 may manage a user account and a separate account for each user. The separate account may be used to accumulate the respective additional amounts for the expected transfers associated with the user's account. In various circumstances, the database engine component 240 may perform searches based on numerous queries, search multiple databases in parallel, and produce search results simultaneously and/or consecutively. Thus, the database engine component 240 may relieve various bottlenecks encountered with conventional servers managing numerous accounts.

Any two or more of the components 232-240 described above may be combined. For example, two or more of the processor component 232, the memory component 234, the data storage component 236, the communication component and/or interface 238, and/or the data engine component 240 may be combined. Further, the combined component may take the form of one or more processors, DSPs, SOCs, FPGAs, and/or ASICs, among other types of processing devices and/or components described herein. For example, the combined component may take the form an SOC that integrates various other components in a single chip with digital, analog, and/or mixed-signal functions, all incorporated within the same substrate. As such, the SOC may be configured to carry out various operations of the components 232-240.

The components 232-240 described above may provide advantages over conventional or general-purpose servers and/or computers. For example, the components 232-240 may enable the system 200 to transfer data over the one or more communication networks 218 to numerous other client devices, such as the client devices 104 and/or 106. In particular, the components 232-240 may enable the system 200 to determine numerous expected transfers of user accounts locally from a single server tray 204. Further, the components 232-240 may determine respective additional amounts for the expected transfers to accumulate target amounts for each account locally from the same server tray 204. In some instances, configuring a separate and/or dedicated processing component 232 to determine expected transfers may optimize operations beyond the capabilities of conventional servers and/or general-purpose processors. As such, the average wait time for the client device 104 to display respective additional amounts accumulated may be minimized accordingly.

It can be appreciated that the system 200, the chassis 202, the trays 204 and 206, the slots 208 and 210, the power supply 212, the communication network 218, and the components 232-240 may be deployed in other ways. The operations performed by components 232-240 may be combined or separated for a given embodiment and may be performed by a greater number or fewer number of components or devices. Further, one or more components or devices may be operated and/or maintained by the same or different entities.

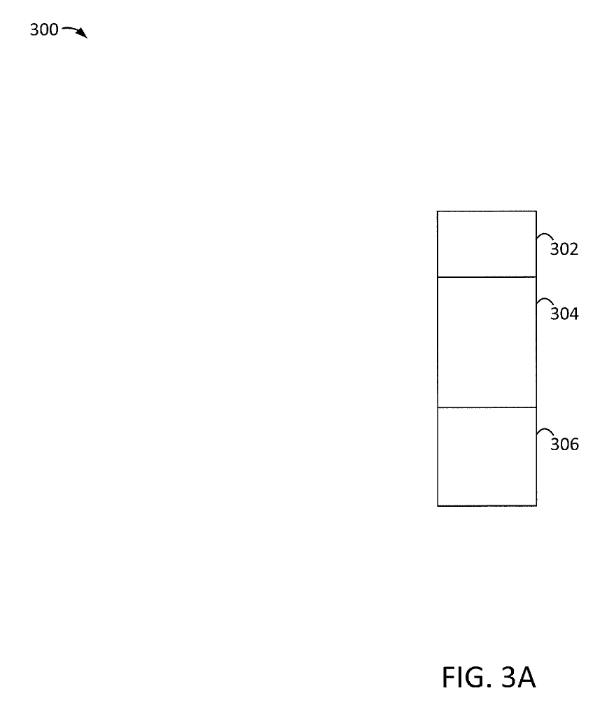

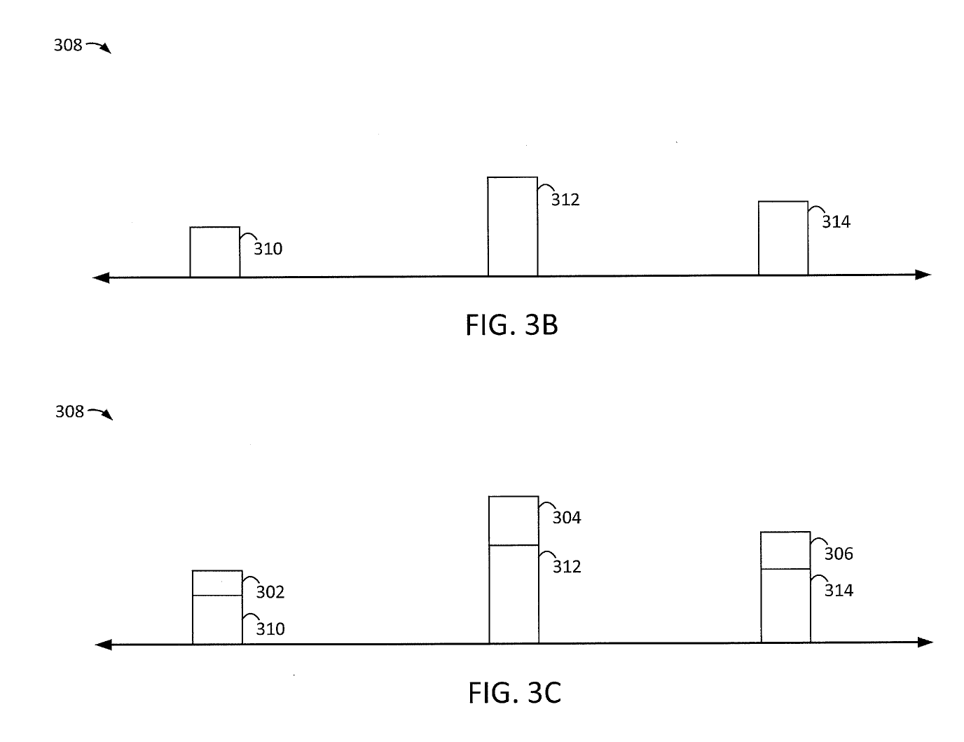

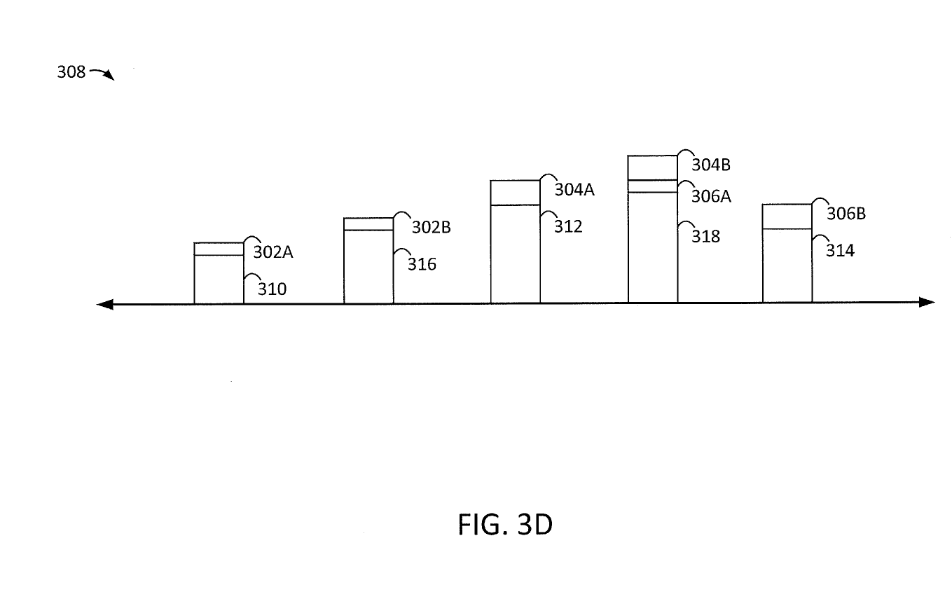

FIG. 3A illustrates a target amount 300, according to an embodiment. In some instances, a server system, such as the server system 102 and/or the server tray 204, may determine the target amount 300, possibly from a user request received. The target amount 300 may be an amount of funds that one or more users wishes to save, possibly to purchase a desired item or a target item.

In some instances, the server system 102 may receive a user request in the data/data packet 122 transmitted from the client device 104. As such, the server system 102 may determine the user of the client device 104 wishes to save the target amount 300 to obtain an available item, such as a desired t-shirt, for example. In some instances, the server system 102 may determine a number of expected transfers associated with the user account. Further, the server system 102 may determine respective additional amounts 302, 304, and/or 306 for each of the number of expected transfers. As shown, the accumulation or sum of the respective additional amounts 302, 304, and/or 306 may be greater than or equal to the target amount 300. Notably the target amount 300 may take the form of one or more valuable resources, materials, supplies, properties, and/or other types of assets, among other possibilities. For example, the target amount 300 may be an amount of gold, silver, and/or other composition of materials that may be valuable.

FIG. 3B illustrates a number of expected transfers 310, 312, and/or 314, according to an embodiment. In some instances, a server system, such as the server system 102 and/or the server tray 204, may determine the target amount 300 associated with an available item and the time period 308 to accumulate the target amount 300. Further, the server system 102 may determine a number of expected transfers 310, 312, and/or 314 that corresponds to the time period 308. For example, the expected transfers 310, 312, and/or 314 may be expected transfers of a user during the time period 308, where the time period 308 may be a given day of the week. Yet, in some instances, the expected transfers 310, 312, and/or 314 may be expected transfers of the user during the time period 308, where the time period 308 may be a week, a number of weeks, a month, and/or other time periods to accumulate the target amount. Notably, there may be more or less expected transfers than the expected transfers 310, 312, and/or 314.

Considering one or more of the scenarios above, the server system 102 may determine the expected transfers 310, 312, and/or 314 based on one or more patterns of the user transfers. As noted, the time period 308 may reflect a given week. As such, the expected transfers 310, 312, and/or 314 may represent expected transfers based on one or more patterns of the user making transfers from the user's account to buy coffee, breakfast, and/or lunch, for example. For instance, the expected transfer 310 may be an expected transfer on Monday, the expected transfer 312 may be an expected transfer on Tuesday, and the expected transfer 314 may be an expected transfer on Wednesday, among other possibilities.

FIG. 3C illustrates a number of respective additional amounts 302, 304, and 306, according to an embodiment. As shown, the respective additional amounts 302, 304, and/or 306 may be determined for the expected transfers 310, 312, and/or 314, respectively, possibly corresponding to the time period 308. As such, the respective additional amounts 302, 304, and/or 306 may be withdrawn or deducted from a user's account along with the expected transfers 310, 312, and/or 314. As illustrated, the respected amounts 302, 304, and/or 306 may be determined based on the expected transfers 310, 312, and/or 314, respectively. For example, the respective additional amount 302 may be proportional to the expected transfer 310, the respective additional amount 304 may be proportional to the expected amount 312, and/or the respective additional amount 306 may be proportional to the expected amount 314. As such, the user may be less likely to realize or recognize the respected amounts 302, 304, and/or 306 additionally withdrawn or deducted with the expected transfers 310, 312, and/or 314 at the time of the withdrawals or deductions. Yet further, an accumulation or sum of the respective additional amounts 302, 304, and/or 306 may be greater than or equal to the target amount 300 shown in FIG. 3A.

In some instances, a server system, such as the server system 102 and/or the server tray 204, may receive a user request based on an input to a graphical user interface (GUI) of a client device, such as the client device 104. As noted, the server system 102 may determine the target amount 300 associated with an available item and the time period 300 to accumulate the target amount 300. As shown in FIG. 3C, the server system 102 may determine a number of expected transfers 310, 312, and/or 314 that corresponds to the time period 308. Notably, the respective additional amounts 302, 304, and/or 306 are provided merely for illustration to demonstrate an accumulation of the respective additional amounts 302, 304, and/or 306 to equal the target amount 300, and should not be interpreted to be limiting in any way.

In particular, the number of expected transfers 310, 312, and/or 314 may be associated with a user account, possibly accessed by the client device 104. Thus, the server system 102 may determine the amounts 302, 304, and/or 306 for the number of expected transfers 310, 312, and/or 314, respectively, such that an accumulation or sum of the respective additional amounts 302, 304, and/or 306 is greater than or equal to the target amount 300. In some instances, the server system 102 may cause the GUI of the client device 104 to display the respective additional amounts 302, 304, and/or 306 with the number of expected transfers 310, 312, and/or 314, possibly as shown in FIG. 3C.

FIG. 3D illustrates a number of additional transfers 316 and 318, according to an embodiment. As shown, the additional transfers 316 and 318 may be additional expected transfers, possibly similar to the expected transfers 310, 312, and/or 314. As such, the respective additional amounts 302, 304, and/or 306 may be distributed or broken down further based on the expected transfers 310, 312, and 314, and the additional transfers 316 and 318. In particular, the respective additional amount 302 may be distributed or broken down further into respective additional amounts 302A and 302B, and/or other amounts. Further, the respective additional amount 304 may be distributed or broken down further into respective additional amounts 304A and 304B, and/or other amounts. Yet further, the respective additional amount 306 may be distributed or broken down further into respective additional amounts 306A and 306B, and/or other amounts.

For illustrative purposes, the server system 102 may determine the additional expected transfers 316 and/or 318 based on various forms of data received, possibly from one or more client devices, such as the client devices 104 and/or 106. As noted, the server system 102 may determine the expected transfer 310 based on data indicating the user regularly buys lunch as described above, possibly based on data/data packet 122 received from the user's client device 104. Yet, the server system 102 may also determine or predict the additional transfer 316, possibly based on the data/data packet 122 indicating the user is buying lunch for a friend as well, possibly also based on data/data packet 124 received from the friend's client device 106. For example, the data/data packet 124 may include details of a calendar meeting or invite that indicates a lunch between the user and the friend. As such, the expected transfer 310 may be determined for the user's lunch and the additional transfer 316 may be determined for the friend's lunch.

In some embodiments, the additional transfers 316 and 318 may be determined at various times within the time period 308. For example, considering the scenarios above, the server system 102 may determine the additional transfer 316 based on the expected transfer 310, possibly determining the additional transfer 316 approximately near or at the same time when the expected transfer 310 is made or processed. As such, the respective additional amounts 302A and 302B may be withdrawn or deducted from the user's account accordingly, possibly approximately near or at the same time. Further, server system 102 may determine the additional transfer 318 based on the expected transfers 312 and/or 314, possibly determining the additional transfer 318 approximately near or at the same time as when the expected transfers 312 and/or 314 are processed. In some embodiments, one or more hardware processors 112 of the server system 102 may be configured to read instructions to cause the server system 102 to perform further operations. For example, the operations may include determining a number of additional transfers 316 and/or 318 that corresponds to the time period 308. Further, the operations may include determining second respective additional amounts 302A, 302B, 304A, 304B, 306A, and/or 308B for the number of expected transfers 310, 312, and/or 314, and the number of additional transfers 316 and/or 318 such that a second accumulation or sum of the second respective additional amounts 302A, 302B, 304A, 304B, 306A, and/or 308B is greater than or equal to the target amount 300.

In some embodiments, a change in the target amount 300 may be detected. For illustration, considering the scenarios above, the target amount of the target item (e.g., the barbecue grill) may increase, decrease (e.g., go on sale), and/or otherwise fluctuate over the time period 308 and/or over other subsequent time periods. For example, the server system 102 may track pricing of the target item based on the brand, model, design, and/or other characteristics or identifiers of the target item. In particular, the server system 102 may search the one or more networks 108 for the target item and/or other similar items to determine updates or changes to the target amount 300. As such, the server system 102 may determine second respective additional amounts 302A, 304A, and/or 306B for the number of expected transfers 310, 312, and/or 314, respectively. Further, the second accumulation or sum of the second respective additional amounts 302A, 304A, and/or 306B may be greater than or equal to the changed target amount. Notably, the respective additional amounts 302B, 304B, and/or 306A may not be necessary to save for the changed target amount and may not be withdrawn from the user's account.

In some embodiments, the one or more hardware processors 112 may be configured to read instructions to cause the server system 102 to perform further operations. For example, the operations may include determining a change in the target amount 300 and determining the second respective additional amounts 302A, 304A, and/or 306B for the number of expected transfers 310, 312, and/or 314 such that a second accumulation or sum of the second respective additional amounts 302A, 304A, and/or 306B is greater than or equal to the changed target amount. In some embodiments, the operations causing the I/O interface 130 of the client device 104, including a graphical user interface, to display the respective additional amounts with the number of expected transfers 310, 312, and/or 314 includes causing the graphical user interface to display the second respective additional amounts 302A, 304A, and/or 306B with the number of expected transfers 310, 312, and/or 314, respectively.

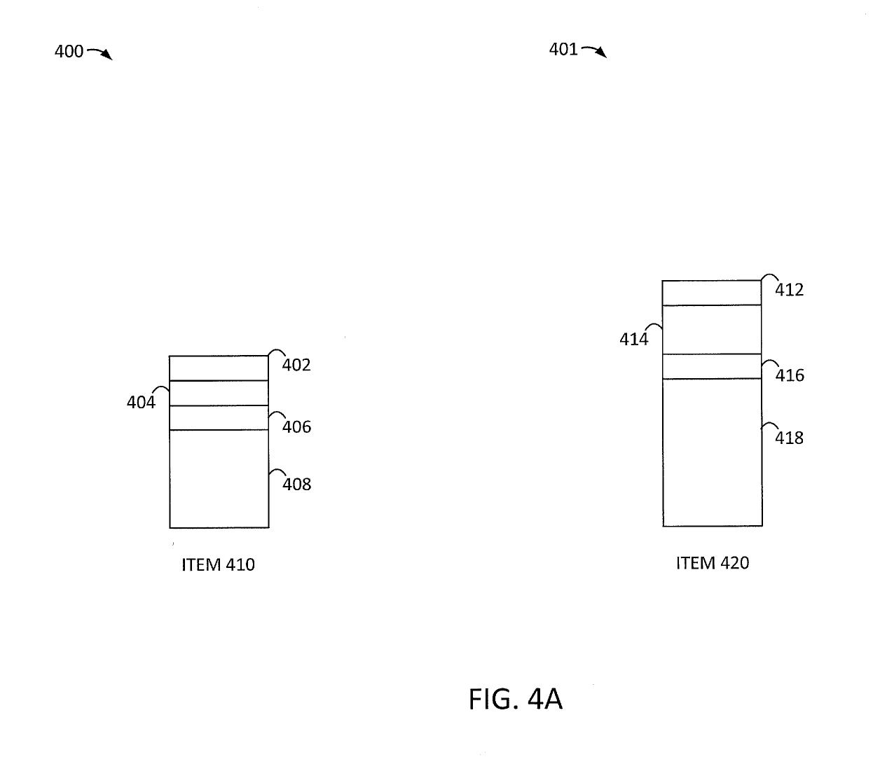

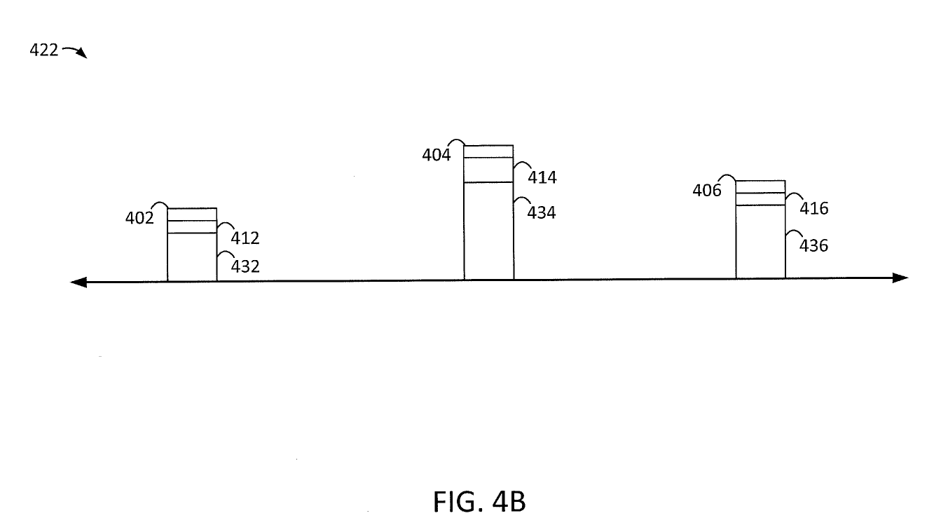

FIG. 4A illustrates a number of target amounts 400 and 401, according to an embodiment. As shown, the target amounts 400 and 401 may take the form of the target amount 300. In some instances, a server system, such as the server system 102 and/or the server tray 204, may determine the target amounts 400 and/or 401, possibly from a user request received. The target amounts 400 and/or 401 may be amounts of funds that one or more users wish to save, possibly to obtain the target items 410 and/or 420, respectively. For example, the target amount 400 may be used to obtain the target item 410 (e.g., the barbecue grill) and the target amount 401 may be used to obtain the target item 420 (e.g., the lawnmower).

As noted, the server system 102 may determine a number of expected transfers associated with a user account. As shown in FIG. 4A, the server system 102 may determine a number of respective additional amounts 402, 404, 406, and/or 408 of the target amount 400 for the number of expected transfers. Further, the server system 102 may determine a number of respective additional amounts 412, 414, 416, and/or 418 of the target amount 401 for the number of expected transfers. As shown, the respective additional amounts 408 and/or 418 may be broken down further and are provided merely for illustrative purposes and should not be interpreted to be limiting in any way.

FIG. 4B illustrates a number of respective additional amounts 402, 404, 406, 412, 414, and/or 416, according to an embodiment. As shown, a first amount 402 for the target amount 400 may be deducted or withdrawn from the user's account with the expected transfer 432. Further, a first amount 412 for the target amount 401 may be deducted or withdrawn from the user's account with the expected transfer 432. Yet further, a second amount 404 for the target amount 400 may be deducted or withdrawn from the user's account with the expected transfer 434. In addition, a second amount 414 for the target amount 401 may be deducted or withdrawn from the user's account with the expected transfer 432. Further, a third amount 406 for the target amount 400 may be deducted or withdrawn from the user's account with the expected transfer 436. Yet further, a third amount 416 for the target amount 401 may be deducted or withdrawn from the user's account with the expected transfer 432. As shown, these above amounts may be deducted or withdrawn, possibly within the time period 422.

In some embodiments, there may be a priority associated with a number of items, including the items 410 and/or 420. In some instances, an indication of the priority may be included in the user request to save the target amounts 400 and 401. As such, in some instances, the respective additional amounts 402, 404, and/or 404 of the target amount 400 may be greater or less than the respective additional amounts 412, 414, and/or 416 of the target amount 401. For example, consider a scenario where the server system 102 determines the item 420 is prioritized higher than the item 410. As such, in FIG. 4B, the server system 102 may determine a greater respective additional amount 414 for the target amount 401 than the respective additional amount 404 for the target amount 400, possibly to save for the target amount 401 before the target amount 400. In particular, the server system 102 may determine the expected transfer 434 to be greater than other expected transfers 432 and/or 436. As such, the server system 102 may determine the respective additional amounts 404 and/or 414 according to the priority of the item 420 being higher than the priority of the item 410.

As noted, the server system 102 may include the one or more hardware processors 112 configured to read instructions to cause the server system 102 to perform operations. For example, the operations may also include determining, based at least on a user request received, the second target amount 401 associated with the second available item 420. Further, the operations may include determining second respective additional amounts 412, 414, 416 for the number of expected transfers 432, 434, and/or 436 such that a second accumulation or sum of the second respective additional amounts 412, 414, and 416 is greater than or equal to at least a portion of the second target amount 401. In some embodiments, the one or more hardware processors 112 may be configured to read the instructions to cause the server system 102 to perform further operations. For example, the operations may include determining, based at least on the user request received, a first priority of a first available item and a second priority of the second available item, where the respective additional amounts 402, 404, and/or 406 and the second respective additional amounts 412, 414, and/or 416 are determined based further on the first priority and the second priority.

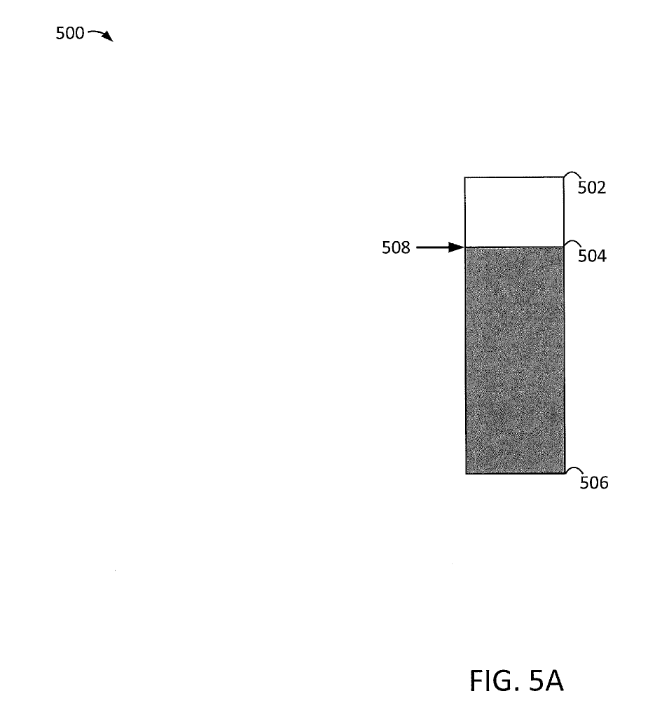

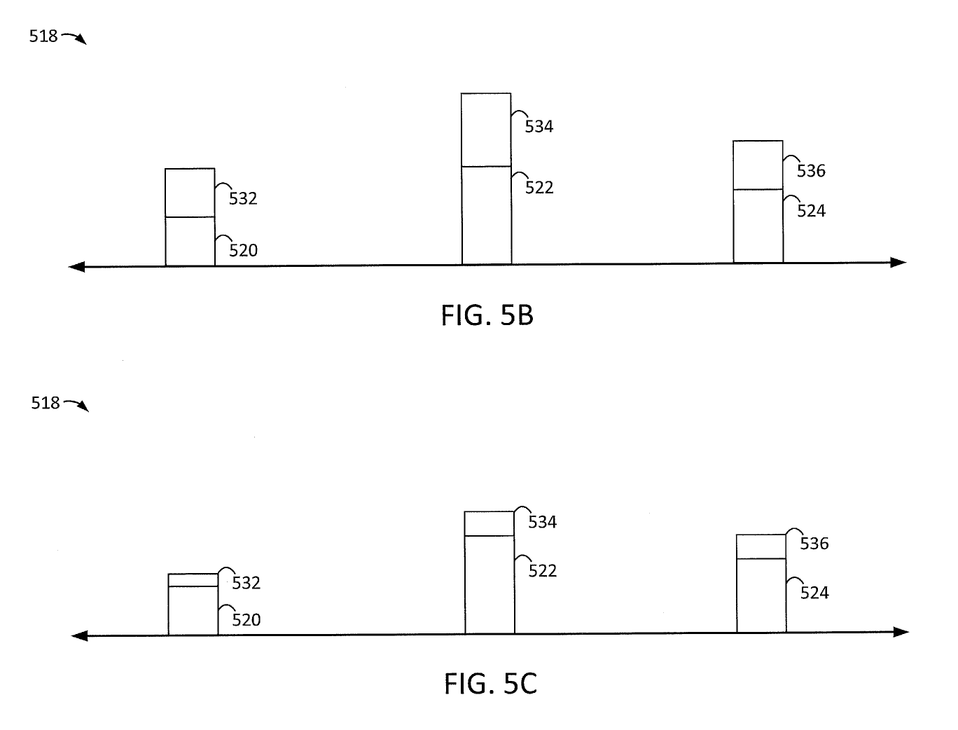

FIG. 5A illustrates a balance 500, according to an embodiment. As shown, the balance 500 may include a current balance 504, possibly indicating a current amount of funds in the user's account. Further, the balance 500 may include an upper balance, possibly indicating a higher balance previously held in the balance 500. Yet further, the balance 500 may include a lower balance 506, possibly indicating a lower balance previously held in the balance 500.

In some embodiments, the present balance 504 may be compared with a given threshold balance, such as the threshold balance 508 in FIG. 5A. As such, based on the comparison, respective additional amounts for a number of the expected transfers may be determined accordingly. For example, consider a scenario where the present balance 504 falls below the threshold balance 508. Referring back to FIG. 4B, the respective additional amounts 402 and/or 412 for the expected transfer 432 may be reduced or eliminated. Further, consider a scenario where the present balance 504 increases above the threshold balance 508. Referring back to FIG. 4B, the respective additional amounts 402 and/or 412 for the expected transfer 432 may be increased accordingly.

As noted, the server system 102 may include the one or more hardware processors 112 configured to read instructions to cause the server system 102 to perform operations. For example, the operations may include determining the present balance 504 of the user account in comparison with the threshold balance 508 of the user account. As such, the respective additional amounts 402, 404, 406, 412, 414, and/or 416 for the number of expected transfers 432, 434, and/or 436 may be determined based further on the present balance 504 of the user account in comparison with the threshold balance 508.

FIG. 5B illustrates an increase in respective additional amounts 532, 534, and/or 536, according to an embodiment. For example, the respective additional amounts 532, 534, and/or 536 may correspond to the respective additional amounts 302, 304, and/or 306 described above in relation to FIG. 3C. Further, the expected transfers 520, 522, and/or 524 may correspond to the expected transfers 310, 312, and/or 314, respectively.

As noted, the server system 102 may include the one or more hardware processors 112 configured to read instructions to cause the server system 102 to perform operations. For example, the operations may include determining the present balance 504 is greater than the threshold balance 508 of the user account. Further, the operations may include determining an increase in the respective additional amounts 532, 534, and/or 536 for the number of expected transfers 520, 522, and/or 524 based at least on the present balance 504 being greater than the threshold balance 508 of the user account.

FIG. 5C illustrates a decrease in respective additional amounts 532, 534, and/or 536, according to an embodiment. As noted, the respective additional amounts 532, 534, and/or 536 may correspond to the respective additional amounts 302, 304, and/or 306 described above in relation to FIG. 3C. Further, the expected transfers 520, 522, and/or 524 may correspond to the expected transfers 310, 312, and/or 314, respectively.

As noted, the server system 102 may include the one or more hardware processors 112 configured to read instructions to cause the server system 102 to perform operations. For example, the operations may include determining the present balance 504 is lower than the threshold balance 508 of the user account. Further, the operations may include determining a decrease in the respective additional amounts 532, 534, and/or 536 for the number of expected transfers 520, 522, and/or 524 based at least on the present balance 504 being less than the threshold balance 508 of the user account.

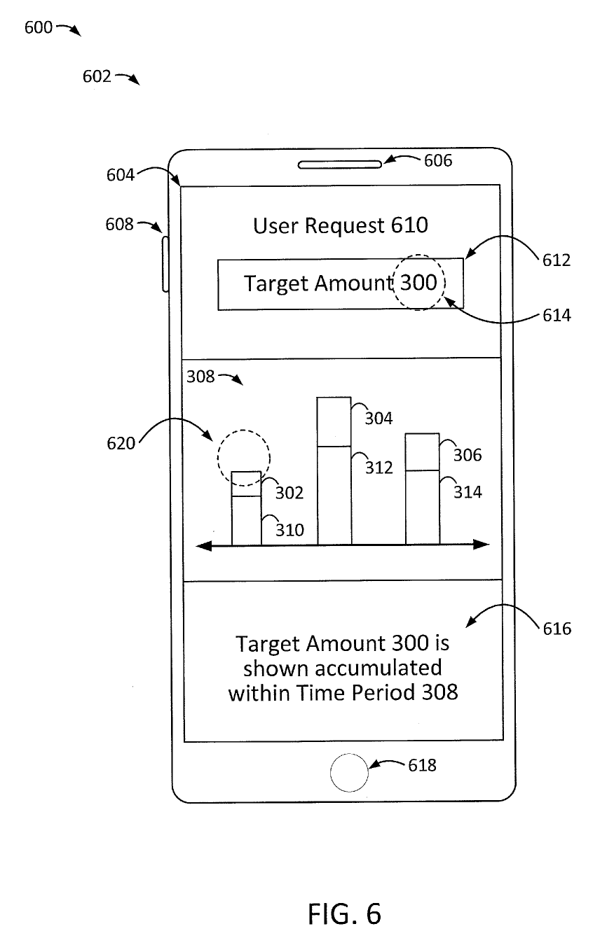

FIG. 6 illustrates an exemplary system 600 with a client device 602, according to an embodiment. In some embodiments, the system 600, possibly referred to a smartphone system 600, may take the form of the system 100 such that, for example, the client device 602 takes the form of the client device 104. As shown, the smartphone system 600 may include a display providing a graphical user interface 604, a speaker/microphone 606, and a button 608, among other possible hardware components. The smartphone system 600 may also include a non-transitory machine-readable medium having stored thereon machine-readable instructions executable to cause a machine such as the smartphone system 600 to perform operations. The smartphone system 600 may also include one or more hardware processors that may take the form of the processor 134. The one or more hardware processors may be coupled to the non-transitory machine-readable medium and configured to read the instructions to cause the smartphone system 600 to perform operations.

In some embodiments, the operations may include determining the target amount 300 described above from a user request 610 received, where the user request 610 is received based at least on an input 612 to the graphical user interface 604 of the smartphone system 600. For example, the input 612 to the graphical user interface 604 may correspond to one or more touch inputs to the graphical user interface 604. As shown in FIG. 6, the target amount 300 may take the form of an amount of funds, among other possibilities contemplated herein. The operations may include determining the number of expected transfers 310, 312, and/or 314 of the time period 308 based at least on the target amount 300, where the number of expected transfers 310, 312, and/or 314 is associated with one or more user accounts. The operations may also include determining a number of additional amounts 302, 304, and/or 306 for the number of expected transfers 310, 312, and/or 314 in the time period 308 such that an accumulation or sum of the number of respective additional amounts 302, 304, and/or 306 is greater than or equal to the target amount, as described above in relation to FIGS. 3A-5C. The operations may include causing the graphical user interface 604 to display the number of additional amounts 302, 304, and/or 306 for the number of expected transfers 310, 312, and/or 314. Further, as shown, the notification 616 on the graphical user interface 604 may indicate, “Target Amount 300 is shown accumulated within Time Period 308.”

In some embodiments, the smartphone system 600 may receive a number of inputs with the graphical user interface 604. For example, the operations of the smartphone system may include determining a second input 620 to the graphical user interface 640. The second input 620 may include a touch input, an input with a stylus, and/or an input with another object, for example. As shown, the second input 620 may indicate a requested change to a given amount 302 of the number of additional amounts 302, 304, and/or 306 described above. For example, the second input 620 may include one or more touch inputs indicating a requested change to increase the amount 302. As such, the operations may include determining a second number of additional amounts 304 and/or 306 for the number of expected transfers 312 and/or 314. In particular, based on the requested change to increase the given amount 302, the second number of additional amounts 304 and/or 306 may decrease accordingly. As such, a second accumulation or sum of the amount 302 and the second (decreased) amounts 304 and 306 may be equal the target amount 300. In another example based on the requested change to the given amount 302 including a requested increase to the given amount 302, FIG. 5C may illustrate the one or more of the second number of additional amounts 534 and/or 536. As shown, the one or more of the second number of additional amounts 534 and/or 536 may be less than respective additional amounts 304 and/or 306 of the number of additional amounts 312 and/or 314 determined for the number of expected transfers 312 and/or 314.

In some embodiments, the smartphone system 600 may receive one or more inputs 614 with the graphical user interface 604 that indicates a change to the target amount 300. For example, the one or more inputs 614 may indicate a change to increase or decrease the target amount 300. Thus, the operations of the smartphone system 600 may include determining a change in the target amount 300, possibly through the one or more inputs 614. Further, the operations may include determining a second number of additional amounts 534 and/or 536 for the number of expected transfers 312 and/or 314 such that a second accumulation or sum of the second respective additional amounts 534 and/or 436 is greater than or equal to the changed target amount 300. As shown, the graphical user interface 604 may provide the change in the target amount 300 and the second respective additional amounts 532, 534, and/or 536.

In some embodiments, referring back to FIG. 4A, the smartphone system 600 may receive one or more inputs 612 and/or 614 to indicate a number of target amounts 400 and/or 401 associated with the target items 410 and/or 420, respectively. Notably, the target amount 400 may be associated with a first item 410. Further, the operations of the smartphone system 600 may include determining, based at least on the user request received 610, the second target amount 401 associated with the second item 420. Yet further, the operations may include determining a second number of additional amounts 412, 414, and/or 416 for the number of expected transfers 432, 434, and/or 436, respectively such that a second accumulation or sum of the second number of additional amounts 412, 414, and/or 416 is greater than or equal to at least a portion of the second target amount 401.

In some embodiments, the smartphone system 600 may also provide with the graphical user interface 604 an account identifier, an email address identifier, and/or a phone number identifier that represents a user. Further, the smartphone system 600 may provide a device identifier (e.g., an IP address of the smartphone system 600 and/or a token identifier based on the smartphone system 600 communicating with other devices). Further, the graphical user interface 604 may be configured to receive multiple touch inputs, possibly at substantially the same time. For example, the graphical user interface 604 may be configured to receive one or more touch inputs 604 to indicate changes to the amounts 302, 304, and/or 306. In practice, for instance, the user may touch both the amounts 302 and/or 304 at the same time or substantially simultaneously to increase the amounts 302 and/or 304, respectively. Further, the button 618 may include a fingerprint sensor to detect a fingerprint from one or more users to authenticate the target amount 300 and/or the respective additional amounts 302, 304, and/or 306. For example, the one or more touch inputs 620 may be simultaneously provided while the fingerprint sensor detects a fingerprint of the user.

Notably, various operations of the smartphone systems 600 may be performed with one or more mobile applications, possibly downloadable by the smartphone systems 600. For example, a mobile application, possibly referred to as a “mobile app” or “app,” may be developed and/or downloaded by the smartphone systems 600 based on a set of application programming interface (API) data sets. In some embodiments, one or more APIs may include a payload or a set of input fields associated with a request. In some instances, the API operations may have both required and/or optional input fields. For example, the following fields may include one or more parameters in the payload associated with the target amounts 300, 400 and/or 401, described above.

### USER=<Your_APIUserRequest>&

### PWD=<Your_APIPassword>&

### METHOD=RespectiveAmounts&

### VERSION=78&

### QTY=TargetAmount300&

cancelUrl=http://www.example.com/cancel.html&
returnUrl=http://www.paypal.com/targetamount300.html

As illustrated, the above fields may include parameters, e.g., minimum parameters, that may be included or possibly required in a payload associated with the user request 610 to save for the target amount 300, for example. In particular, various parameters may include a user request shown above as “USER,” a password shown above as “PWD,” a method of saving shown above as “METHOD” and “RESPECTIVE ADDITIONAL AMOUNTS” (e.g., saving amounts 302, 304, and/or 306 as described above), and quantity for the target amount 300 shown above as “QTY” and “TARGET AMOUNT.”

In some embodiments, the service provider may activate an application, possibly an “app” installed on a client device, e.g., the client device 602, owned or operated by the user. In particular, the service provider may activate the app to alert the user that the target amount 300 has been accumulated. The app may also alert the user that the target amount 300 has changed due to one or more prices of a target item corresponding to the target amount 300 monitored by the service provider. In some instances, the service provider may cause the app to provide identification or description changes to the respective additional amounts 302, 304, and/or 306. Further, the app may trigger an alert to change the respective additional amounts 302, 304, and/or 306 to accumulate the target amount 300 in a sale provided for a limited time as described above.

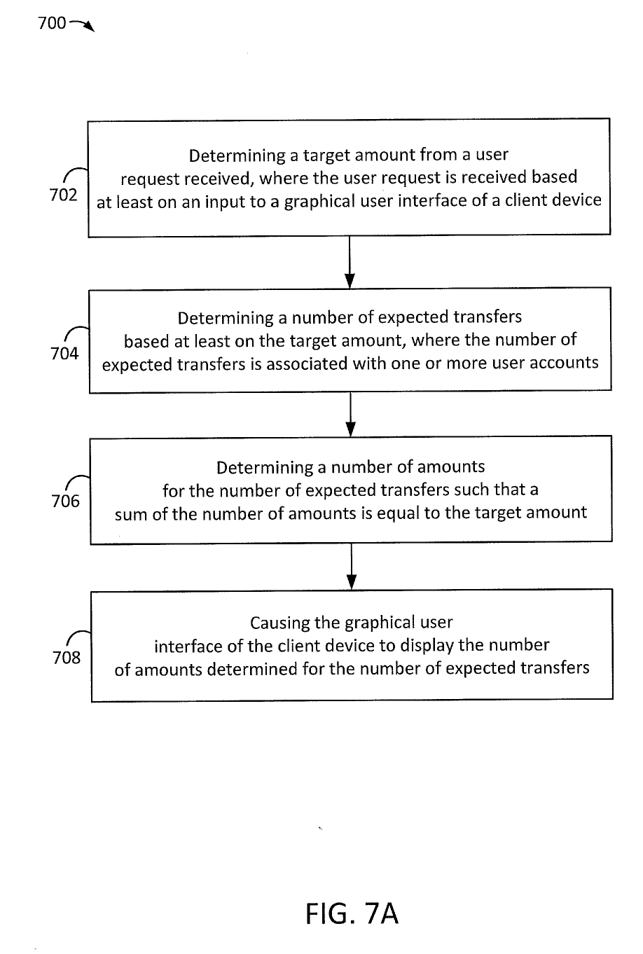

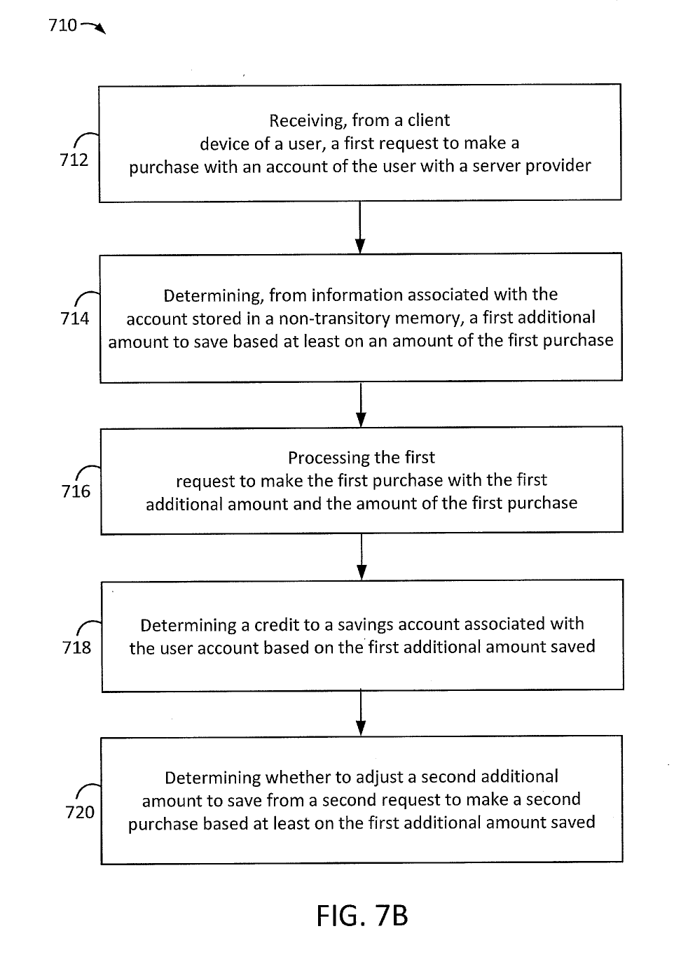

FIG. 7A illustrates an exemplary method 700, respectively, according to an embodiment. Notably, one or more steps of the method 700 described herein may be omitted, performed in a different sequence, and/or combined with other methods for various types of applications contemplated herein.

As shown in FIG. 7A, at step 702, the method 700 may include determining a target amount from a user request received, where the user request is received based at least on an input to a graphical user interface of a client device. For example, the method 700 may include one or more hardware processors (e.g., the hardware processors 112 and/or 232) of a server (e.g., the server 102 and/or server tray 204) determining a target amount. In particular, referring back to FIGS. 4A and 4B, the target amount 400 may be determined from the user request received, where the user request is received based on an input to a graphical user interface of a client device. For example, referring back to FIG. 6, the user request may be received based on the inputs 612 and/or 614 to the graphical user interface 604.

At step 704, the method 700 may include determining a number of expected transfers based at least on the target amount, where the number of expected transfers is associated with one or more user accounts. For example, the method 700 may include the one or more hardware processors (e.g., the hardware processors 112 and/or 232) determining a number of expected transfers. For example, referring back to FIGS. 4A and 4B, the number of expected transfers 432, 434, and/or 436 may be determined based at least on the target amount 400, where the number of expected transfers 432, 434, and/or 436 is associated with one or more user accounts described above.

At step 706, the method 700 may include determining a number of amounts for the number of expected transfers such that a sum of the number of amounts is greater than or equal to the target amount. For example, the method 700 may include determining, by the one or more hardware processors (e.g., processors hardware 112 and/or 232), a number of amounts. For example, referring back to FIGS. 4A and 4B, the amounts 402, 404, and/or 406 for the number of expected transfers 432, 434, and/or 436 may be determined such that a sum of the amounts 402, 404, and/or 406 is greater than or equal to a portion of the target amount 400.

At step 708, the method 700 may include causing the graphical user interface of the client device to display the number of amounts determined for the number of expected transfers. For example, the method 700 may include causing the graphical user interface, such as the graphical user interface 604 of the smartphone system 600, to display a number of amounts. In particular, referring back to FIGS. 4A and 4B, the graphical user interface may display a number of the amounts 402, 404, and/or 406 for the number of expected transfers 432, 434, and/or 436, respectively.

In some embodiments, the method 700 may include determining, based at least on the user request received, a second target amount 401 associated with a second item 420. Further, the method 700 may include determining a second number of amounts 412, 414, and/or 416 for the number of expected transfers 432, 434, and/or 436 such that a second sum of the second number of amounts 412, 414, and/or 416 is greater than or equal to at least a portion of the second target amount 401.

FIG. 7B illustrates an exemplary method 710, respectively, according to an embodiment. Notably, one or more steps of the method 700 described herein may be omitted, performed in a different sequence, and/or combined with other methods for various types of applications contemplated herein.

As shown in FIG. 7B, at step 712, the method 710 includes receiving, from a client device of a user, a first request to make a first purchase with an account of the user with a server provider. In particular, the method 710 may include one or more hardware processors (e.g., the hardware processors 112 and/or 232) of a service provider server (e.g., the server 102 and/or server tray 204) receiving the first request. For example, referring back to FIG. 1, the hardware processor 112 may receive the first request in the data packet 122 from the client device 104, where the first request indicates making a first purchase with an account of the user with a service provider.

At step 714, the method 710 includes determining, from information associated with the account stored in a non-transitory memory, a first additional amount saved based at least on an amount of the first purchase. In particular, the method 710 may include one or more hardware processors (e.g., the hardware processors 112 and/or 232) determining the first additional amount to save. For example, referring back to FIGS. 4A and 4B, the first additional amount 402 may be determined based on information associated with an account stored in a non-transitory memory (e.g., the non-transitory memory 114 and/or 234). The first additional amount 402 may be determined based on the amount 432 of the first purchase.

At step 716, the method 710 includes processing the first request to make the first purchase with the first additional amount and the amount of the first purchase. In particular, the method 710 may include one or more hardware processors (e.g., the hardware processors 112 and/or 232) processing the first request. For example, referring back to FIGS. 4A and 4B, the first request may be processed to make the first purchase with the first additional amount 402 and the amount of the first purchase 432.

At step 718, the method 710 includes determining a credit to a savings account associated with the user account based on the first additional amount saved. In particular, the method 710 may include one or more hardware processors (e.g., the hardware processors 112 and/or 232) determining a credit to a savings account associated with the user account. For example, referring back to FIGS. 4A and 4B, the credit may be determined based on the first additional amount 402 saved. In some instances, the savings account may be a separate account from the user account. Yet further, in some instances, the savings account may be a separate portion and/or a partition of the user account.

At step 720, the method 710 includes determining whether to adjust a second additional amount to save from a second request to make a second purchase based at least on the first additional amount saved. In particular, the method 710 may include one or more hardware processors (e.g., the hardware processors 112 and/or 232) determining whether to adjust a second additional amount to save from a second request. For example, referring back to FIGS. 4A and 4B, the second additional amount 404 to be saved may be adjusted to make the second purchase 434, possibly based on the first additional amount 402 saved.

In some embodiments, the first purchase 432 described above may be an unexpected purchase and the second purchase 434 described above may be an expected purchase. In such instances, the second additional amount 404 to save from the second request is decreased based on at least on the first additional amount 402 saved with the unexpected purchase. Notably, the second additional amount 404 may be decreased in real-time, possibly just prior to processing the second purchase 434.

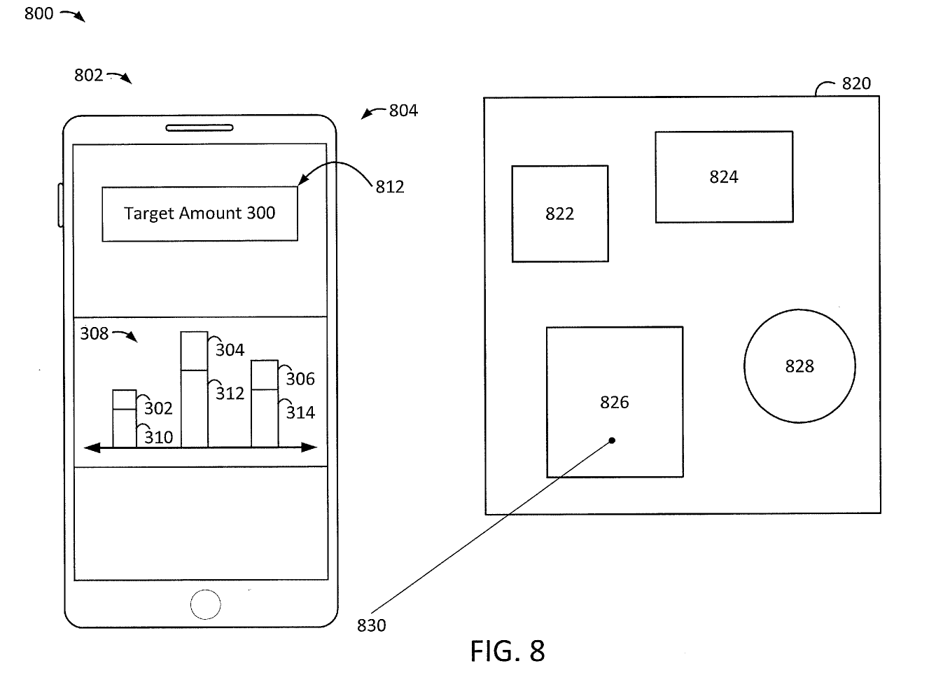

FIG. 8 illustrates an exemplary system 800 with a client device 802, according to an embodiment. As shown, the client device 802 may take the form of the client device 602. For example, the client device 802 may include a graphical user interface 804 that takes the form of the graphical user interface 604. In particular, the graphical user interface 804 is configured to receive the input 812 that may take the form of the input 612 described above. As such, the graphical user interface 804 may provide the target amount 300. Further, the graphical user interface 804 may provide the amounts 302, 304, and/or 306 along with the expected transfers 310, 312, and/or 314, respectively, possibly in the time period 308.

As shown, the client device 802 may be in a location 830 shown on the geographical map 820, shown for illustrative purposes. For example, the client device 802 may be proximate to the buildings 822, 824, 826, and/or 828 shown on the geographic map 820. In particular, the client device 802 may be at a location 830 within the building 826. In some instances, the one or more hardware processors (e.g., the processor 134) of the client device 802 may be configured to determine the location 830, possibly based on global positioning system (GPS) coordinates of the client device 802.

In some embodiments, the system 800 may determine the location 830 of the client device 802. Referring back to FIG. 7A, for example, the method 700 may include determining, by the one or more hardware processors (e.g., processors 112 and/or 232), one or more locations 830 of the client device 802 proximate to one or more buildings 822, 824, 826, and/or 828 based at least on global positioning system (GPS) data retrieved from the client device 802. For example, the server 102, possibly incorporated with the system 800, may require the GPS data from the client device 802 to establish a connection with the server 102, as described above. In some instances, the server 102 may determine the number of expected transfers 302, 304, and/or 306 based further on the location 830 of the client device 802 proximate to the one or more store buildings 822, 824, 826, and/or 828.

In some instances, the one or more hardware processors (e.g., processors 112 and/or 232) may determine the location 830 by retrieving data from the client device 802, possibly including Wi-Fi beaconing data, Enhanced Observed Time Difference (EOTD) data, global positioning System (GPS) data, Assisted GPS (A-GPS) data, Differential GPS (DGPS) data, Time Difference of Arrival (TDOA) data, Angle of Arrival (AOA) data, triangulation data, local transceiver pilot signal data, among other forms of location data described above. Yet further, in some instances, the location 830 may be further determined by cellular protocol data, including GSM, CDMA, UMTS, EV-DO, WiMAX, or LTE data, and/or base station data. In addition, the location 830 may be further determined by sensor data, movement data (e.g., acceleration and/or velocity data) of the client device 802, temperature data, radio-frequency identifier (RFID) data, near-field communications (NFC) data, among other possible forms of data.

In some embodiments, referring back to FIG. 7A, the method 700 may include determining an additional transfer at the one or more store buildings 826 and an amount for the additional transfer. For example, the additional transfer may take the form of one or more of the additional transfers 316 and/or 318 described above in relation to FIG. 3D. As such, the method 700 may include determining a second number of additional amounts 302A, 304A, and/or 306B for the number of expected transfers 310, 312, and/or 314, respectively. In particular, the second number of additional amounts 302A, 304A, and/or 306B may be based at least on the amount for the additional transfers 316 and/or 318. In some instances, a second sum of the second number of additional amounts 302A, 304A, and/or 306B is greater than or equal to at least a portion of the target amount 300.

In some embodiments, referring back to FIG. 7B, the method 710 may include determining the location 830 of the client device 802 proximate to one or more store buildings 822, 824, 826 and/or 828 based at least on global positioning system (GPS) data retrieved from the client device 802. Further, the second additional amount saved may be adjusted based further on the location 830 of the client device 802 proximate to the one or more store buildings 822, 824, 826 and/or 828. Further, in some embodiments, the method 710 may include determining a number of expected transfers with the one or more store buildings 822, 824, 826 and/or 828, where the second additional amount saved is decreased based on the number of expected transfers determined.

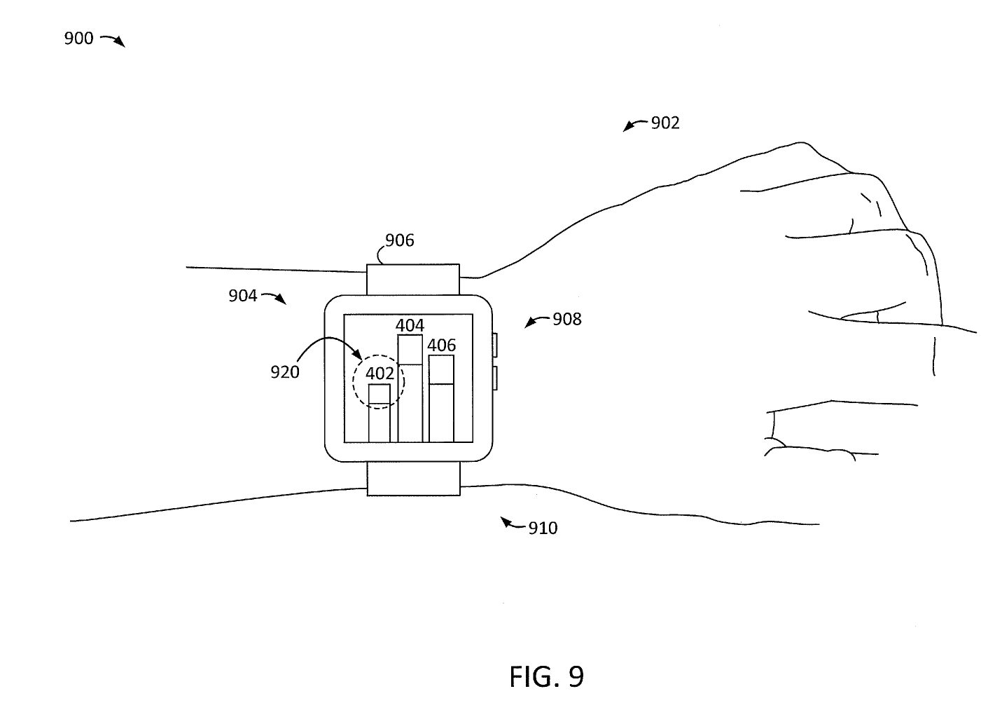

FIG. 9 illustrates an exemplary wearable computing device 900, according to an embodiment. As illustrated, the wearable computing device 900 may take the form of a smart watch. Further, the wearable computing device 900 may include a graphical user interface (GUI) 904 that may include aspects of the graphical user interfaces 604 and/or 804. Yet further, the wearable computing device 900 may include a wrist band 906 that secures around a user's wrist 902. In addition, the wearable computing device 900 may include a number of buttons 908 configured to control the GUI 904 and/or sensors 910. The sensors 910, possibly located on the inside surfaces of the wrist band 906, may be configured to receive a number of inputs associated with the user. For example, the one or more sensors 910 may include accelerometers, gyroscopes, compasses, barometers, capacitive sensors, haptic sensors, temperature sensors, ambient light sensors, sound sensors, image sensors, biometric sensors, moisture sensors, electrodes, and/or chemical sampling sensors, among other types of sensors to receive inputs directly and/or indirectly from the user.

As shown, the graphical user interface 904 may provide the amounts 402, 404, and/or 406 with the expected transfers 432, 434, and/or 436, possibly based on one or more inputs received by the graphical user interface 904. In some embodiments, referring back to FIG. 7A, the method 700 may include determining a second input 920 to the graphical user interface 904 that indicates a requested change to a given amount 402 of the number of additional amounts 402, 404, and/or 406, as similarly described above. Further, the method 700 may include determining a change to the number of additional amounts 404 and/or 406 to a “second” number of additional amounts for the number of expected transfers 434 and/or 436, respectively, based at least on the requested change to the given amount 402, as noted above. Further, a second sum of the second number of respective additional amounts 402, 404, and/or 406 may be greater than or equal to at least a portion of the target amount 400. In some instances, the requested change to the given amount 402 may include a requested change to decrease to the given amount 402. Further, one or more of the second number of additional amounts 404 and/or 406 may be increased such that the amounts are greater than the amounts 404 and/or 406 displayed before the requested change.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

1. A system, comprising:
a non-transitory memory; and
one or more hardware processors coupled to the non-transitory memory and configured to execute instructions to cause the system to perform operations comprising:
receiving a user request based at least on an input to a graphical user interface of a client device;
determining, based at least on the user request received, a target amount associated with an available item and a time period to accumulate the target amount;
determining, using a hardware location determination component installed on the client device, a location of the client device;
identifying a total number of transaction locations located within a predefined proximity to the location of the client device;
determining a plurality of expected transfers based on the total number of transaction locations and the time period, wherein the plurality of expected transfers is associated with a user account of the client device and each expected transfer, in the plurality of transfers, is expected to take place at a transaction location in the plurality of locations;
determining a respective additional amount for each of the plurality of expected transfers such that an accumulation of the respective additional amounts is greater than or equal to the target amount; and
causing the graphical user interface of the client device to display the respective additional amounts with the plurality of expected transfers.

2. The system of claim 1, wherein the operations further comprise:
determining a plurality of additional transfers that corresponds to the time period; and
determining second respective additional amounts for the plurality of expected transfers and the plurality of additional transfers such that a second accumulation of the second respective additional amounts is greater than or equal to the target amount.

3. The system of claim 1, wherein the operations further comprise:
determining a change in the target amount; and
determining second respective additional amounts for the plurality of expected transfers such that a second accumulation of the second respective additional amounts is greater than or equal to the changed target amount.

4. The system of claim 3, wherein causing the graphical user interface of the client device to display the respective additional amounts with the plurality of expected transfers comprises causing the graphical user interface to display the second respective additional amounts with the plurality of expected transfers.

5. The system of claim 1, wherein the operations further comprise:
determining, based at least on the user request received, a second target amount associated with a second available item; and
determining second respective additional amounts for the plurality of expected transfers such that a second accumulation of the second respective additional amounts is greater than or equal to at least a portion the second target amount.

6. The system of claim 5, wherein the operations further comprise:
determining, based at least on the user request received, a first priority of the available item and a second priority of the second available item, wherein the respective additional amounts and the second respective additional amounts are determined based further on the first priority and the second priority.

7. The system of claim 1, wherein the operations further comprise:
determining a present balance of the user account in comparison with a threshold balance of the user account, wherein the respective additional amounts for the plurality of expected transfers are determined based further on the present balance of the user account in comparison with the threshold balance.

8. The system of claim 7, wherein the present balance is greater than the threshold balance of the user account, and wherein the one or more hardware processors is configured to read the instructions to cause the server system to perform further operations comprising:
determining an increase in the respective additional amounts for the plurality of expected transfers based at least on the present balance being greater than the threshold balance of the user account.

9. The system of claim 1, wherein the operations further comprise:
determining a credit to the user account with the respective additional amounts after each of the plurality of expected transfers is completed.

10. A non-transitory machine-readable medium having stored thereon machine-readable instructions executable to cause a mobile user device to perform operations comprising:
determining a target amount from a user request received, wherein the user request is received based at least on an input to a graphical user interface of the machine;
determining, using a hardware location determination component installed on the mobile user device, a location of the mobile user device;
identifying a total number of transaction locations located within a predefined proximity to the location of the mobile user device;
determining a plurality of expected transfers of a time period based at least on the total number of transaction locations and the target amount, wherein the plurality of expected transfers is associated with one or more user accounts and each expected transfer, in the plurality of transfers, is expected to take place at a transaction location in the plurality of locations;
determining a plurality of additional amounts for the plurality of expected transfers in the time period such that a sum of the plurality of additional amounts is greater than or equal to the target amount; and
causing the graphical user interface to display the plurality of amounts determined for the plurality of expected transfers.

11. The non-transitory machine-readable medium of claim 10, wherein the operations further comprise:
determining a second input to the graphical user interface that indicates a requested change to a given amount of the plurality of additional amounts determined for the plurality of expected transfers; and
determining a second plurality of additional amounts for the plurality of expected transfers based at least on the requested change to the given amount, wherein a second sum of the second plurality of additional amounts is greater than or equal to at least a portion of the target amount.

12. The non-transitory machine-readable medium of claim 10, wherein the requested change to the given amount comprises a requested increase to the given amount, and wherein one or more of the second plurality of additional amounts is less than the plurality of additional amounts determined for the plurality of expected transfers.

13. The non-transitory machine-readable medium of claim 10, wherein the operations further comprise:
determining a change in the target amount; and
determining a second plurality of additional amounts for the plurality of expected transfers such that a second sum of the second plurality of additional amounts is greater than or equal to the changed target amount.

14. The non-transitory machine-readable medium of claim 13, wherein causing the graphical user interface to display the plurality of additional amounts determined for the plurality of expected transfers comprises causing the graphical user interface to display the change in the target amount and the second plurality of additional amounts for the plurality of expected transfers.

15. The non-transitory machine-readable medium of claim 10, wherein the target amount is associated with a first item, and wherein the operations further comprise:
determining, based at least on the user request received, a second target amount associated with a second item; and
determining a second plurality of additional amounts for the plurality of expected transfers such that a second sum of the second plurality of additional amounts is greater than or equal to at least a portion of the second target amount.

16. The non-transitory machine-readable medium of claim 10, wherein the operations further comprise:
determining a credit to the user account with the plurality of additional amounts after each of the plurality of expected transfers is completed.

17. A method, comprising:
receiving, from a client device of a user, a first request to make a first purchase with an account of the user with a server provider;
determining, from information associated with the account stored in a non-transitory memory, a first additional amount to save based at least on an amount of the first purchase;
processing the first request to make the first purchase with the first additional amount and the amount of the first purchase;
determining a credit to a savings account associated with the user account based on the first additional amount saved; and
determining whether to adjust a second additional amount to save from a second request to make a second purchase based at least on the first additional amount saved.

18. The method of claim 17, wherein the first purchase is an unexpected purchase and the second purchase is an expected purchase, wherein the second additional amount to save from the second request is decreased based on at least on the first additional amount saved with the unexpected purchase.

19. The method of claim 17, further comprising determining a location of the client device proximate to one or more store buildings based at least on global positioning system (GPS) data retrieved from the client device, wherein the second additional amount saved is adjusted based further on the location of the client device proximate to the one or more store buildings.

20. The method of claim 19, further comprising determining a plurality of expected transfers with the one or more store buildings, wherein the second additional amount saved is decreased based on the plurality of expected transfers determined.
